(19) United States
(12) Patent Application Publication
(10) Pub. No.: US 2008/0016443 A1
(43) Pub. Date: Jan. 17, 2008

(54) Navigation device and simple/detailed information display method

(75) Inventors: Toshiaki Hiroshima, Hitachinaka-shi (JP); Kazuo Fukuda, Kawagoe-shi (JP)

Correspondence Address: CROWELL & MORING LLP;INTELLECTUAL PROPERTY GROUP, P.O. BOX 14300, WASHINGTON, DC, 20044-4300, US

(73) Assignee: XANAVI INFORMATICS CORPORATION, Zama-shi (JP)

(21) Appl. No.: 11/730,701

(22) Filed: Apr. 3, 2007

(30) Foreign Application Priority Data
Apr. 4, 2006 (JP) 2006-102771

(51) Int. Cl. G06F 3/01

(52) U.S. Cl. 715/702; 715/727

(57) ABSTRACT

A navigation device includes: a display monitor equipped with a touch panel with a display screen assuming a substantially rectangular shape; a display control unit that displays specific simple information over part of the display screen along a side of the display screen or in a corner of the display screen; and a touch position detection unit that detects a touch in a display area where the simple information is provided and then detects that a touch position of the touch has moved inward from an edge of the display screen. As the touch position detection unit detects that the touch position has moved, the display control unit displays at the display screen detailed information related to the simple information.

### INCORPORATION BY REFERENCE

The disclosure of the following priority application is herein incorporated by reference:
Japanese Patent Application No. 2006-102771 filed Apr. 4, 2006

### BACKGROUND OF THE INVENTION

1. Field of the Invention

The present invention relates to a navigation device that enables display of various types of information by using part of a display screen on which a roadmap is displayed and a display method to be adopted when displaying simple/detailed information at the navigation device.

2. Description of Related Art

There is a navigation device known in the related art that displays on a navigation screen a status bar providing simple information related to an audio source and an entertainment key and brings up a display of detailed information on the audio source at a monitor display unit if the entertainment key is touched (see Japanese Laid Open Patent Publication No. 2004-132741).

### SUMMARY OF THE INVENTION

The entertainment key cannot be displayed over a large area in the navigation device disclosed in Japanese Laid Open Patent Publication No. 2004-132741, since buttons enabling audio operations also must be displayed. Thus, the user, wishing to display the detailed information on the audio source, needs to first locate the position at which the entertainment key is displayed before he is able to touch the entertainment key. This gives rise to a problem in that the user performing the operation for displaying the detailed information may be distracted from the driving operation.

According to the 1st aspect of the present invention, a navigation device comprises: a display monitor equipped with a touch panel with a display screen assuming a substantially rectangular shape; a display control unit that displays specific simple information over part of the display screen along a side of the display screen or in a corner of the display screen; and a touch position detection unit that detects a touch in a display area where the simple information is provided and then detects that a touch position of the touch has moved inward from an edge of the display screen, and as the touch position detection unit detects that the touch position has moved, the display control unit displays at the display screen detailed information related to the simple information.

According to the 2nd aspect of the present invention, in the navigation device according to the 1st aspect, it is preferred that: the display control unit displays the simple information in a display screen in which a roadmap is displayed; and the touch position detection unit detects that the touch position has moved from the display area for the simple information into the display area for the roadmap.

According to the 3rd aspect of the present invention, in the navigation device according to the 2nd aspect, it is preferred that: as the detailed information is brought up on display, the display control unit displays simple roadmap information related to the roadmap along a side of the display screen or in a corner of the display screen; and as a touch in a display area for the simple roadmap information is detected and then a the touch position of the touch is detected to have moved from the display area for the simple roadmap information to the display area for the detailed information, the display control unit displays the roadmap and displays the simple information related to the detailed information along a side of the display screen or in a corner of the display screen.

According to the 4th aspect of the present invention, in the navigation device according to any one of the 1st through 3rd aspects, it is preferred that: there is further provided an audio function operation unit that executes operation by engaging an audio function; the simple information is simple information related to the operation executed by engaging the audio function; and the detailed information is detailed information related to the operation executed by engaging the audio function.

According to the 5th aspect of the present invention, in the navigation device according to any one of the 1st through 3rd aspects, it is preferred that: there is further provided a traffic information reception unit that receives traffic information; the simple information is a simplified version of the traffic information; and the detailed information is a detailed version of the traffic information.

According to the 6th aspect of the present invention, in the navigation device according to the 1st or the 2nd aspect, it is preferred that the display control unit displays a plurality of types of simple information in different display areas.

According to the 7th aspect of the present invention, in the navigation device according to the 1st or the 2nd aspect, it is preferred that the display control unit alters contents of the detailed information in correspondence to the touch position at which the display area for the simple information is touched, as detected by the touch position detection unit.

According to the 8th aspect of the present invention, in the navigation device according to any one of the 1st through 7th aspects, it is preferred that the display control unit alters contents of the simple information on display as a touch in the display area for the simple information is detected.

According to the 9th aspect of the present invention, a simple/detailed information display method comprises: displaying a specific type of simple information at a display monitor equipped with a touch panel disposed at a substantially rectangular display screen, over part of the display screen along a side of the display screen or in a corner of the display screen; detecting a touch in a display area where the simple information is provided and then detecting that a touch position of the touch has moved inward from an edge of the display screen; and displaying detailed information related to the simple information over the display screen upon detecting that the touch position has moved.

### BRIEF DESCRIPTION OF THE DRAWINGS

FIG. 1 is a block diagram showing the structure adopted in the navigation device achieved in an embodiment of the present invention;

FIG. 2 shows a screen that may be displayed at the display monitor as route guidance is provided while playing a CD;

FIG. 3 shows an audio information screen;

FIG. 4 presents a flowchart of the display changeover processing executed to switch between the simple audio information and the detailed audio information;

FIG. 5 presents a flowchart of the display changeover processing executed to switch between the simple audio information and the detailed audio information;

FIG. 6 shows another display mode that may be adopted when providing the simple information;

FIG. 7 shows a screen that may be displayed to provide two types of simple information;

FIG. 8 shows a screen that may be displayed to provide detailed information related to air-conditioning;

FIG. 9 illustrates how a plurality of types of detailed information operations that may be accessed from a simple information display;

FIG. 10 shows a given type of detailed information among the plurality of types of detailed information that may be accessed from a simple information display;

FIG. 11 shows another type of detailed information among the plurality of types of detailed information that may be accessed from a simple information display; and

FIG. 12 illustrates an operation that may be performed to change the contents displayed over the simple information display area.

### DESCRIPTION OF PREFERRED EMBODIMENT

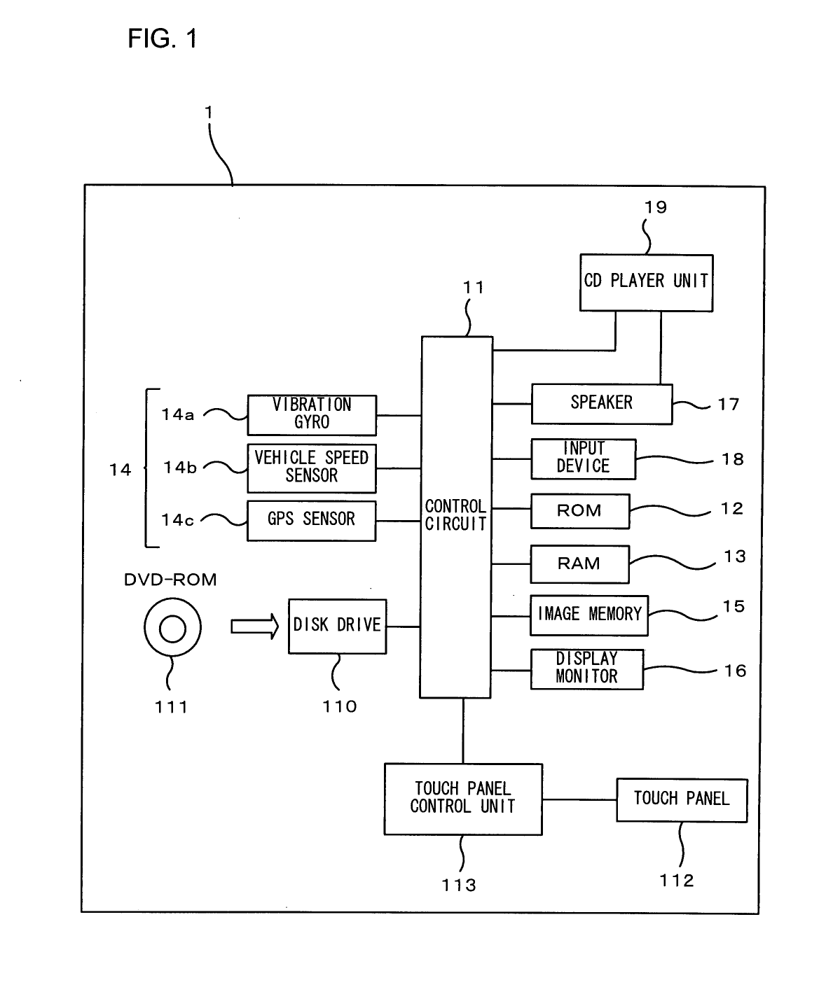

FIG. 1 shows the structure adopted in the navigation device achieved in an embodiment of the present invention. At a navigation device 1 in FIG. 1, which has a navigation function such as map display, CDs (compact discs) can be played and information related to the music being played can be displayed at a display monitor 16. The navigation device 1, which is installed in a vehicle, comprises a control circuit 11, a ROM 12, a RAM 13, a current position detection device 14, an image memory 15, the display monitor 16, a speaker 17, an input device 18, a CD player unit 19, a disk drive 110, a touch panel 112 and a touch panel control unit 113. A DVD-ROM 111 having recorded therein map data is loaded into the disk drive 110.

The control circuit 11, constituted with a microprocessor and its peripheral circuits, implements various types of control by using the RAM 13 as its work area as it executes a control program stored in the ROM 12. As the control circuit 11 executes a specific type of route search processing based upon the map data stored in the DVD-ROM 111, the processing results are displayed as a recommended route at the display monitor 16.

The current position detection device 14, which detects the current position of the subject vehicle, maybe constituted with, for instance, a vibration gyro 14a that detects the vehicle advancing direction, a vehicle speed sensor 14b that detects the vehicle speed, a GPS sensor 14c that detects a GPS signal from a GPS (global positioning system) satellite, and the like. Based upon the current vehicle position detected by the current position detection device 14, the navigation device 1 determines a map display area, a route search start point and the like and indicates the current position on the map.

Image data of images to be displayed at the display monitor 16 are stored in the image memory 15. The image data, which include roadmap drawing data and various types of graphic data, are generated as needed based upon the map data read via the disk drive 110 from the DVD-ROM 111. By using the image data thus generated, the navigation device 1 is able to display a map and the like.

The disk drive 110 reads out map data to be used to display the map at the display monitor 16 from the DVD-ROM 111 loaded therein. The map data include map display data and route search data. The route search data include link information and node information pertaining to the roads in the map data. The map display data include a plurality of sets of map data each provided at a specific scaling factor among various scaling factors ranging from wide-area to detailed, and the scaling factor for the map display can be adjusted at a request from the operator of the navigation device 1 (the user of the navigation device or a crew in the vehicle). It is to be noted that the map data may be read out from a recording medium other than the DVD-ROM 111, such as a CD-ROM or a hard disk.

Various types of information including a roadmap of an area around the subject vehicle position are provided as screen display to the operator of the navigation device 1 via the display monitor 16 based upon various types of information including the map data. In addition, audio information such as the operating status of the CD player unit 19 and information on the music currently being played at the CD player unit 19 is displayed at the display monitor 16. Audio messages providing operation instructions or route guidance are output through the speaker 17. The sound reproduced via the CD player unit 19 is also output through the speaker 17.

The input device 18 includes input switches through which a vehicle destination and the like can be set by the user. Such an input device may be an operation panel or a remote control unit. Prompted by instructions displayed on the screen at the display monitor 16 or audio instructions output from the speaker 17, the user operates the input device 18 so as to select and set a specific destination. In addition, the CD player unit 19 can be operated via the input device 18 so as to, for instance, play a CD loaded in the CD player unit 19 or select a tune recorded on the CD.

As a destination is set by the user, the navigation device 1 executes a route calculation based upon a specific algorithm to determine a route to the destination starting from the current position detected via the current position detection means 14. In the following explanation, this route calculation is referred to as a route search. The route thus determined (hereafter referred to as a recommended route) is indicated on the screen by adopting a specific display mode that makes it possible to distinguish the route from the other roads, e.g., by using a different display color. As a result, the user is able to recognize the recommended route in the map on display with ease. In addition, the navigation device 1 guides the vehicle so as to enable the vehicle to travel along the recommended route by providing the user with visual cues on the screen or audio instructions along the advancing direction.

The CD player unit 19 reproduces a CD and outputs the reproduced sound to the speaker 17. A plurality of CDs can be loaded into the CD player unit 19, and the CD player unit 19 outputs audio information such as artist information and album information recorded on the CD to the control circuit 11.

The touch panel 112 is a transparent touch switch layered over the surface of the display monitor 16 and an image displayed at the display monitor 16 is viewed through the touch panel 112. Thus, as the display screen of the display monitor 16 is pressed, the touch panel 112 recognizes a touch. The touch panel 112 outputs a signal corresponding to an operation position on the touch panel 112 to the touch panel control unit 113, which, in turn, calculates the touch position at the touch panel 112. As does the input device 18, the touch panel 112 has an input function. As any of various buttons or a display menu brought up on screen is touched with a finger or the like, an instruction for the execution of the processing defined in correspondence to the button or menu item can be entered.

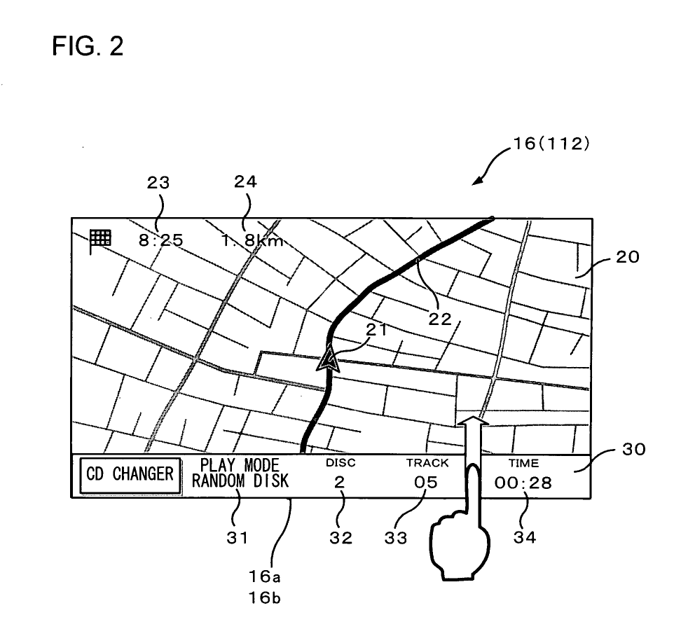

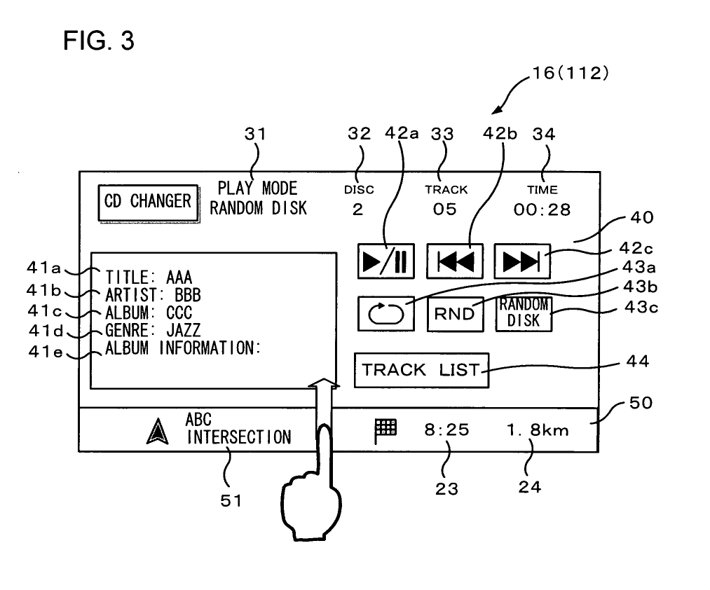

Next, in reference to FIGS. 2 and 3, the display changeover operation executed to switch between a simple audio information display and a detailed audio information display is explained. In this description, the term “simple audio information” refers to a simplified version of the audio information, which includes the operating status of the CD player unit 19 and information on the music currently being played at the CD player 19, whereas the term “detailed audio information” refers to a detailed version of the information. FIG. 2 shows the display screen brought up at the display monitor 16 as route guidance is provided to the user while playing a CD. An audio information bar 30 is displayed together with a roadmap 20 on the display screen.

In the roadmap 20, a subject vehicle position mark 21 indicating the current vehicle position and a recommended route 22 are displayed. In addition, an expected arrival time 23 at which the vehicle is expected to reach the destination and a distance 24 to the destination are indicated over an upper left area in the roadmap 20.

The audio information bar 30 is a display feature where audio information is displayed and takes up only a small display area so as to allow a full display of the roadmap 20. For this reason, the detailed audio information cannot be displayed in the audio information bar 30 and the simple information is displayed instead. The simple information displayed in the audio information bar 30 includes a play mode 31, a CD number 32 indicating the number assigned to the CD currently being played among a plurality of CDs loaded in the CD player unit, a track number 33 indicating the number of the track currently being played and an elapsed play time 34.

In order to ensure that the display position of the audio information bar 30 can be ascertained with ease by the user by tracing an edge 16a of the display screen without having to look at the display screen, the audio information bar is displayed along the lower side 16b of the substantially rectangular display screen. The edge 16a of the display screen is at the boundary between the display screen and the casing of the display monitor 16 or the main unit and since the materials constituting the display screen and the casing of the display monitor or the main unit are different or a recession or a projection is formed at the boundary, the position of the edge can be easily located by feel.

The user, wishing to obtain detailed information such as the title of the tune currently being played and the name of the artist who recorded the tune, performs the following operation to bring up the detailed information on display. It is assumed that since the user is often the driver of the vehicle, he may not be able to operate the navigation device 1 by visually checking the display screen at the display monitor 16. Accordingly, he brings up the detailed information on the display in advance so that he is able to immediately read the detailed information during short stops at traffic signals and the like.

The user finds the display position of the audio information bar 30 by feel at the edge of the display screen. Since the audio information bar 30 is displayed along the lower side of the substantially rectangular display screen, he is able to find the display position easily. Once the user locates the display position of the audio information bar 30 by feel, the user touches the audio information bar 30 with his finger. Then, he drags his finger along the direction indicated by the arrow in FIG. 2, i.e., along the direction running from the edge toward the central area of the display screen. A decision as to whether or not the touch position has moved is made by detecting whether or not the depressed position at which the user's finger is touching the display screen has moved from the display area of the audio information bar 30 to the display area of the roadmap 20.

As the touch position moves into the display area where the roadmap 20 is displayed, an audio information screen 40 is brought up on display as shown in FIG. 3. In the audio information screen 40 taking up substantially the entire display screen, the detailed audio information is provided. In the audio information screen 40 provides the detailed information such as a title 41a of the tune currently being played, an artist's name 41b of the artist that recorded the tune being played, an album title 41c of the album recorded on the CD, a genre 41d of the music being played and album information 41e on the album is displayed in addition to the play mode 31, the CD number 32, the track number 33 and the elapsed play time 34 displayed in the audio information bar 30.

In the audio information screen 40, operation buttons 42a˜42c operated to start/stop playing a CD and the like, play mode buttons 43a˜43c operated to switch the play mode and a track list button 44 for displaying a list of tunes contained in the CD currently being played are displayed together with the detailed information.

As the audio information screen 40 is brought up on display, a roadmap information bar 50 is also displayed along the lower side of the display screen. Instead of the roadmap itself, simple information which summarizes the information contained in the roadmap 20 in FIG. 2 is displayed in the roadmap information bar 50. This simple information includes a display position 51 indicating the position at which the subject vehicle position mark 21 is currently located, the expected arrival time 23 at which the vehicle is expected to reach the destination and the remaining distance 24 to the destination.

The user wishing to switch to the detailed information display from the simple information display provided in the roadmap information bar 50, i.e., the user wishing to display the roadmap 20, touches the roadmap information bar 50 with his finger and drags the finger along the direction indicated by the arrow in FIG. 3. Once the touch position moves from the display area of the roadmap information bar 50 into the display area for the audio information screen 40, the roadmap 20 in FIG. 2 is brought back on display. In this situation, too, the roadmap 20 can be brought up on display without having to look at the display screen since the roadmap information bar 50 displayed along the lower side of the display screen can be found by feel.

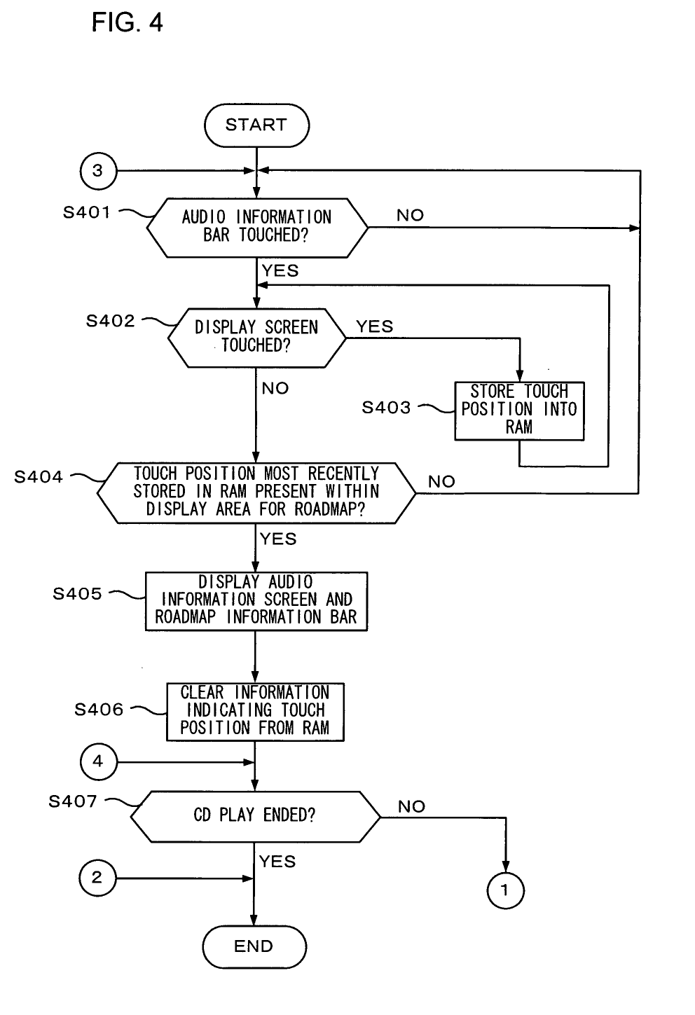

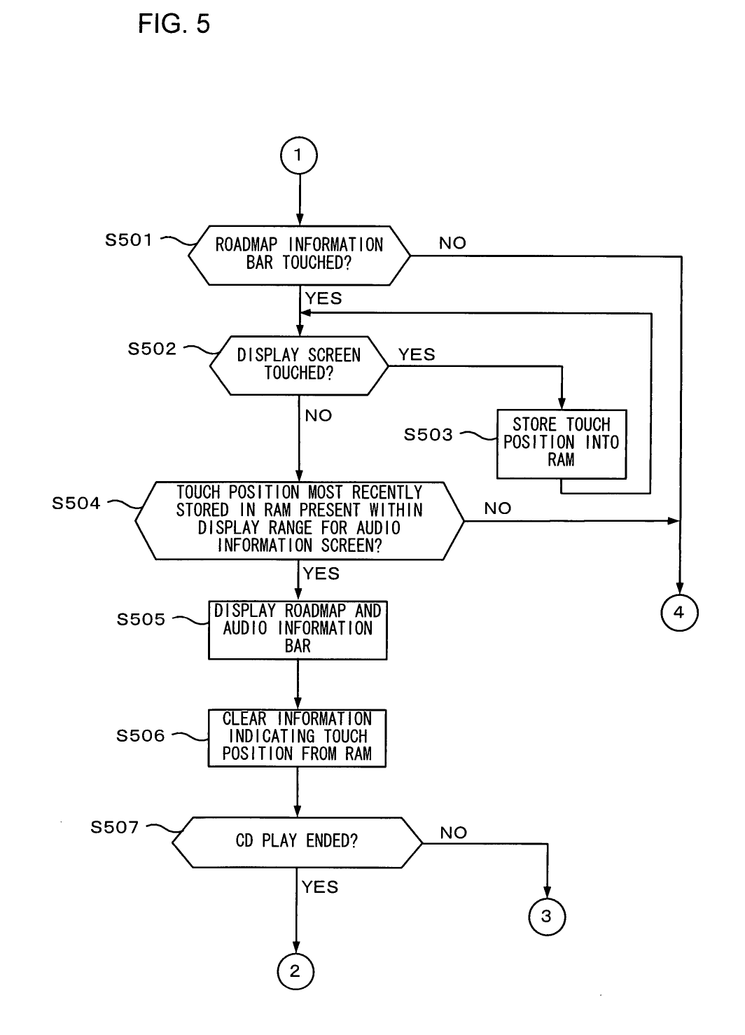

Next, the display changeover processing executed to switch between the simple audio information display and the detailed audio information display is explained in reference to the flowchart presented in FIGS. 4 and 5. The processing in FIGS. 4 and 5 is executed by the control circuit 11 in conformance to a program started up as a CD is accessed in the vehicle being guided along the route. It is assumed that currently, the audio information bar 30 is displayed together with the roadmap 20 at the display screen of the display monitor 16.

In step S401, a decision is made as to whether or not the audio information bar 30 has been touched based upon the touch position at the touch panel 112 calculated by the touch panel control unit 113. An affirmative decision is made in step S401 if the audio information bar has been touched and the operation proceeds to step S402. If, on the other hand, the audio information bar has not been touched, the processing in step S401 is repeatedly executed.

In step S402., a decision is made as to whether or not the display screen has been touched. An affirmative decision is made in step S402 if the display screen has been touched and, in this case, the operation proceeds to step S403. In step S403, the touch position at the touch panel 112 having been calculated by the touch panel control unit 113 is stored into the RAM 13. If the display screen has not been touched, a negative decision is made in step S402 and the operation proceeds to step S404. The control circuit is able to detect that the finger still touching the display screen has been dragged by executing step S402 and step S403 in rapid succession.

In step S404, a decision is made as to whether or not the touch position most recently stored into the RAM 13 is within the display area for the roadmap 20. An affirmative decision is made in step S404 if the touch position is within the display area for the roadmap 20, and in this case, the operation proceeds to step S405. A negative decision is made in step S404 if the touch position is not within the display area for the roadmap 20 and the operation returns to step S401.

In step S405, the audio information screen 40 and the roadmap information bar 50 are brought upon display. In step S406, the touch position information having been stored in the RAM 13 is erased. In step S407, a decision is made as to whether or not the CD play has ended. An affirmative decision is made in step S407 if the CD play has ended and, in this case, the roadmap 20 is brought back up to full screen display and the simple audio information/detailed audio information display changeover processing ends. If, on the other hand, the CD play has not ended, a negative decision is made in step S407 and the operation proceeds to step S501 in FIG. 5.

In step S501, a decision is made as to whether or not the roadmap information bar 50 has been touched. An affirmative decision is made in step S501 if the roadmap information bar has been touched and the operation proceeds to step S502. However, a negative decision is made in step S501 if the roadmap information bar has not been touched and the operation returns to step S407.

In step S502, a decision is made as to whether or not the display screen has been touched. An affirmative decision is made in step S502 if the display screen has been touched and in this case, the operation proceeds to step S503. In step S503, the touch position at the touch panel 112, calculated by the touch panel control unit 113, is stored into the RAM 13. A negative decision is made in step S502 if the display screen has not been touched and the operation proceeds to step S504. The control circuit is able to detect that the finger, still touching the screen, has been dragged by executing step S502 and step S503 in rapid succession.

In step S504, a decision is made as to whether or not the touch position most recently stored into the RAM 13 is within the display area for the audio information screen 40. An affirmative decision is made in step S504 if the touch position is within the display area for the audio information screen 40, and in this case, the operation proceeds to step S505. A negative decision is made in step S504 if the touch position is not within the display area for the audio information screen 40 and the operation returns to step S407.

In step S505, the roadmap 20 and the audio information bar 30 are brought up on display. In step S506, the touch position information having been stored in the RAM 13 is erased. In step S507, a decision is made as to whether or not the CD play has ended. An affirmative decision is made in step S507 if the CD play has ended and, in this case, the roadmap 20 is brought back up to full screen display and the simple audio information/detailed audio information display changeover processing ends. If, on the other hand, the CD play has not ended, a negative decision is made in step S507 and the operation returns to step S401 in FIG. 4.

The following advantages are achieved in the embodiment of the navigation device 1 according to the present invention described above.
(1) The audio information bar 30 providing the simple audio information is displayed along the lower side of the substantially rectangular display screen over which the roadmap 20 is displayed. Thus, the audio information bar 30 can be touched in reference to the edge of the display screen, the position of which can be ascertained by feel without having to look. Then, as the user drags the touch position from the edge of the display screen toward the center of the display screen, the audio information screen 40 providing the detailed audio information can be brought up on display. Since this enables a display screen changeover from the screen display providing the simple audio information to the screen display providing the detailed audio information without having to look at the screen, better convenience for the driver is assured.
(2) When the audio information screen 40 providing the detailed audio information is brought up on display, simple information with regard to the roadmap 20 is also displayed in the roadmap information bar 50 along the lower side of the substantially rectangular display screen. Then, as the roadmap information bar 50 is touched and the touch position is dragged from the edge of the display screen toward the center of the display screen, the roadmap 20 can be brought back up on display. In short, since the display can be switched back to the initial display of the roadmap 20 without having to look, better convenience for the driver is assured.

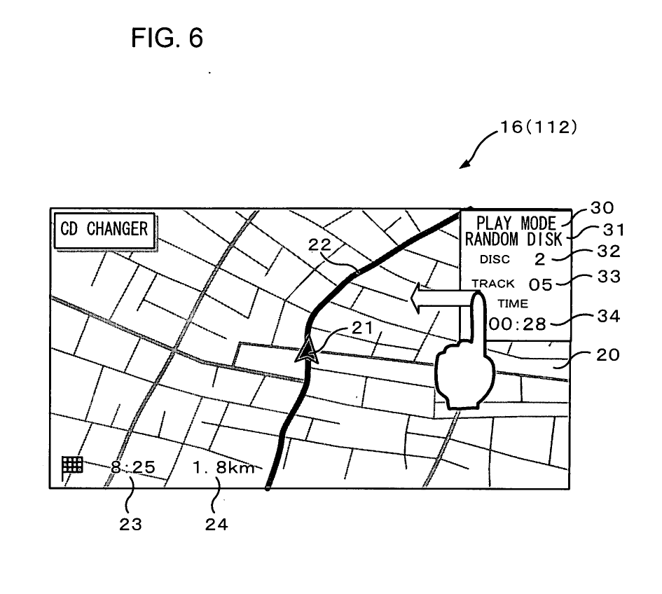

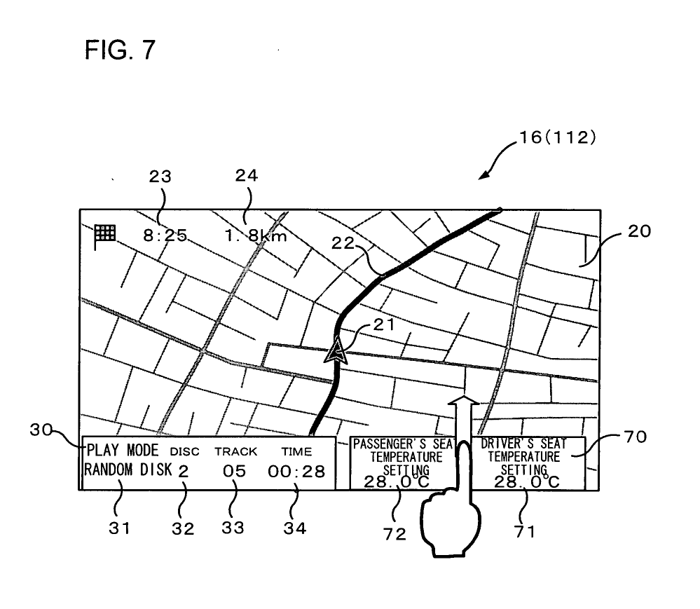

The navigation device 1 achieved in the embodiment described above allows for the following variations.
(1) While the audio information bar 30 and the roadmap information bar 50 providing the simple information are displayed along the lower side of the substantially rectangular display screen, they may be displayed at a position other than the position along the lower side as long as their display position can be ascertained in reference to an edge of the display screen. For instance, they may be displayed along the upper side, the left side or the right side of the substantially rectangular display screen or they may be displayed in a corner of the substantially rectangular display screen. FIG. 6 presents an example of the audio information bar 30 displayed in the upper right corner of the display screen. In this case, too, as the audio information bar 30 is touched and the finger touching the display screen is dragged from the edge of the display screen toward the center of the display screen, as indicated by the arrow, the audio information screen 40 shown in FIG. 3 can be brought up on display. However, it is to be noted that a specific display position assumed for the audio information bar 30 and the roadmap information bar 50, e.g., along the lower side, the upper side, the left side or the right side of the display screen or in a specific corner of the display screen, is set in advance in each navigation device 1, and the driver using the navigation device 1 must read the manual or the like in advance to learn the display position.
(2) The audio information brought up on display is not limited to CD play information, as long as the information relates to operations executed by engaging in the audio function. For instance, information related to the operation performed by engaging an audio function of an MD (MiniDisc) player, TV or radio may be displayed.
(3) Information for which the simple information display/detailed information display changeover is executed is not limited to audio information. For instance, the display changeover may be executed for air-conditioning information pertaining to the air-conditioning system installed in the vehicle or for traffic information such as VICS information distributed from a VICS (vehicle information communication system) information center. The navigation device that executes simple VICS information display/detailed VICS information display changeover must be equipped with a VICS information reception device that receives VICS information transmitted via light beacons, FM broadcasts or the like. As a further alternative, simple information display/detailed information display changeover may be executed for hands-free telephone operation information.
(4) Instead of providing a single type of simple information in the display screen at the display monitor 16, a plurality of types of simple information may each be displayed in a specific display area. For instance, the audio information bar 30 and an air-conditioning information bar 70 providing simple air-conditioning information may be displayed along the lower side of the display screen as shown in FIG. 7.

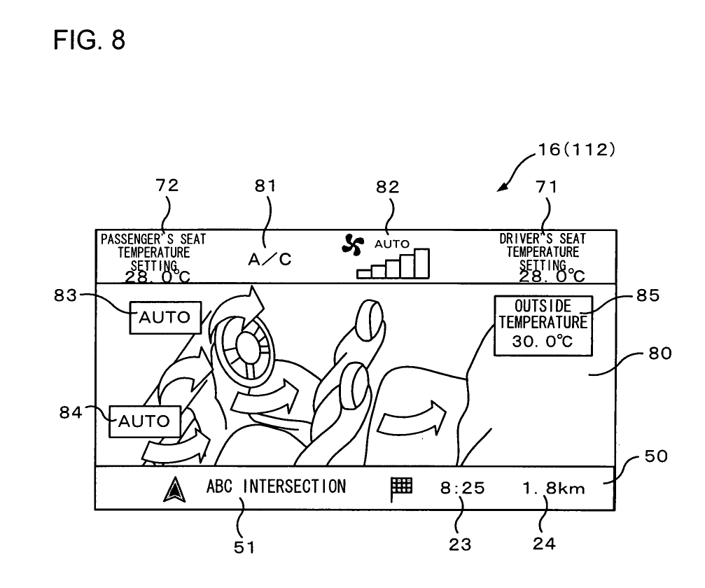

In the air-conditioning information bar 70, a driver's seat temperature setting 71 and a passenger's seat temperature setting 72 are displayed as the simple information. As the air-conditioning information bar 70 is touched with a finger, and the finger is dragged along the direction indicated by the arrow into the display area for the roadmap 20, an air-conditioning information screen 80 can be brought up on display as shown in FIG. 8. In the air-conditioning information screen 80 providing detailed air-conditioning information, an air conditioner ON indicator 81, an airflow indicator 82, a driver's seat outlet state indicator 83, a passenger's seat outlet state indicator 84 and an outside temperature indicator 85 are displayed in addition to the driver's seat temperature setting 71 and the passenger's seat temperature setting 72 displayed in the air-conditioning information bar 70.

Even when a plurality of types of simple information are displayed, the display area allocated for each type of simple information can be ascertained without having to look at the display screen by tracing the edge of the display screen, as long as the display areas for the individual types of simple information are set along different sides of the display screen, e.g., along the upper side, the lower side, the left side and the right side of the display screen, or as long as they are set side-by-side along the upper side or the lower side. When a plurality of types of simple information are provided on display, too, the user is able to bring up a display of the detailed information of a specific type without having to look at the display screen and thus, better convenience for the user is assured.
(6) While an explanation is given above on an example in which the detailed information is brought up on display as the display area providing the simple information is touched and the finger is dragged inward from the edge of the display screen, detailed information with different contents is brought up on display depending upon the position at which simple information display area is first touched.

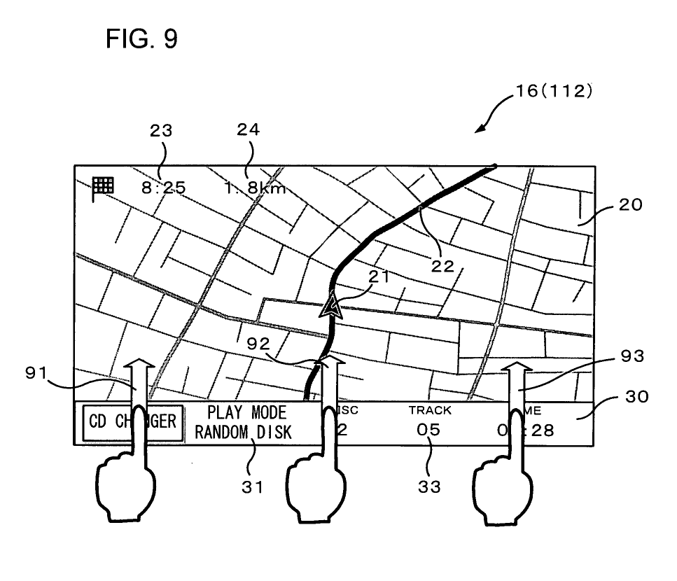

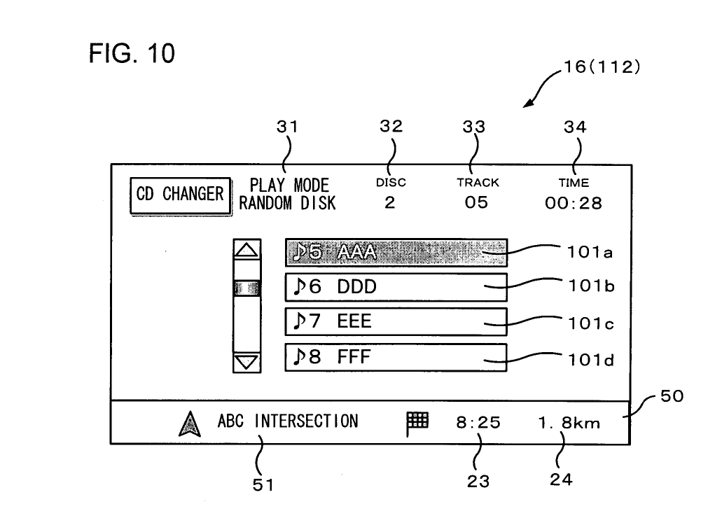

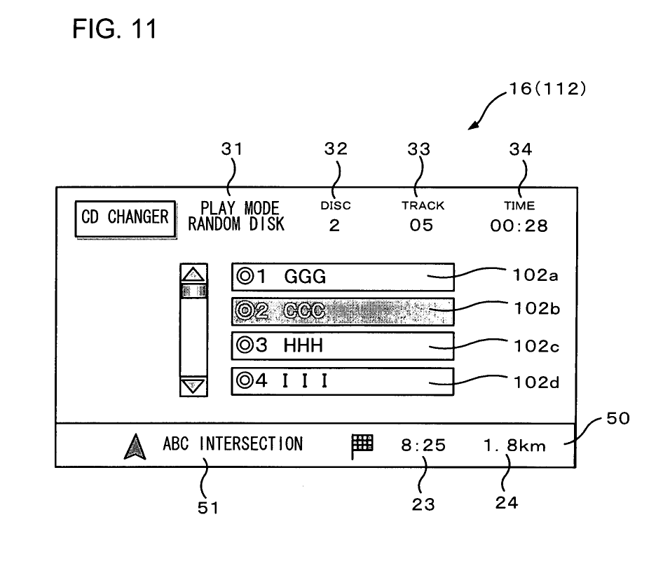

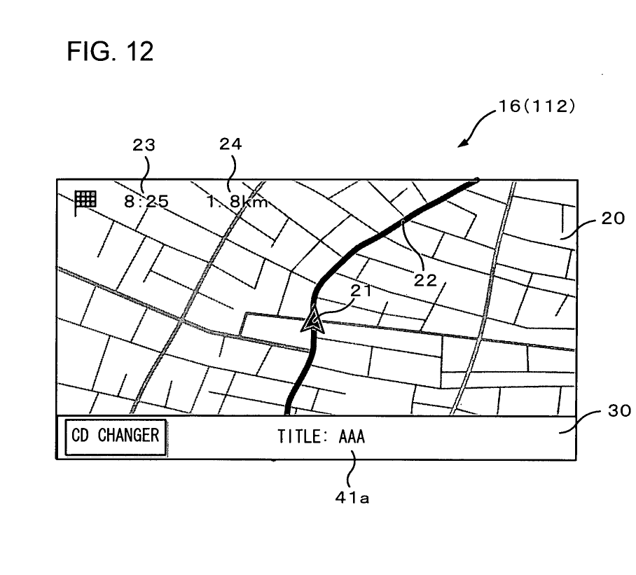

The contents of the detailed information to be brought up on display may be varied as follows. As the left side of the audio information bar 30 is touched with the finger and the finger is dragged along the direction indicated by an arrow 91 as shown in FIG. 9, the detailed information in FIG. 3, which includes the items 41a˜41e related to the music currently being played is brought up on display. As the finger touches an area around the center of the audio information bar 30 and is dragged along a direction indicated by an arrow 92, detailed information (a tune list) in FIG. 10, which includes items 101a˜101d pertaining to the tunes contained in the CD currently being played, is brought up on display. As the finger touches the right side of the audio information bar 30 and is dragged along the direction indicated by an arrow 93, the detailed information (an album list) in FIG. 11, which includes items 102a˜102d related to the CDs loaded in the CD player unit 19, is brought up on display. Since a plurality of types of detailed information can be accessed from a single simple information display area, better convenience for the user is assured.
(7) The contents of the simple information on display may be altered by touching the display area where the simple information is provided and then lifting a finger without moving from the touch position. For instance, as the finger touching the audio information bar 30 shown in FIG. 2 is lifted, the contents of the simple information provided in the audio information bar 30 may be changed to the title 41a of the tune currently being played as shown in FIG. 12 from the play mode 31, the CD number 32, the track number 33 and the elapsed play time 34. Then, as the display area is touched again, the artist name 41b indicating the name of the artist who recorded the tune being played, the album title 41c indicating the title of the album that includes the tune being played and the like may be displayed. By allowing different display contents to be provided in response to a touch in the display area where the simple information is displayed, various types of information can be provided in the simple information display area and, as a result, better convenience for the driver is assured.
(8) While an explanation is given above on an example in which the audio information screen 40 is brought up on display by touching the audio information bar 30 and then dragging the finger into the display area of the roadmap 20, the audio information screen 40 may be brought upon display as the display area for the roadmap 20 is touched after touching the audio information bar 30 without dragging the finger. Namely, the control circuit may determine that the touch position has moved from the audio information bar 30 into the display area for the roadmap 20 upon detecting a touch in the display area for the roadmap 20 within a predetermined length of time after detecting a touch on the audio information bar 30.
(9) The control program executed in the navigation device 1 may be installed in a personal computer so as to enable the personal computer to function as a navigation device. In such a case, the control program, which will enable the personal computer to function as a navigation device, may be provided via a recording medium such as a DVD or a CD-ROM or through a data signal on the Internet or the like. In other words, the control program, which enables the personal computer to function as a navigation device achieving the features described above, can be distributed as a computer readable computer program product adopting any of various modes including a recording medium and a carrier wave. The personal computer to function as a navigation device must be equipped with a touch panel disposed over the display screen.

The navigation device according to the present invention is not limited to the embodiment described above in any way whatsoever, as long as it comprises a display monitor equipped with a touch panel and has a display screen in a substantially rectangular shape, a display control means for displaying specific simple information over part of the display screen along a side of the display screen or in a corner of the display screen and a touch position detection means for detecting a touch in the display area where the simple information is provided and detecting that a touch position has moved inward from an edge of the display screen and is characterized in that as the touch position detection means detects that the touch position has moved, the display control means displays detailed information related to the simple information on the display screen.

The above described embodiment is an example, and various modifications can be made without departing from the spirit and scope of the invention.

What is claimed is:

1. A navigation device, comprising:
a display monitor equipped with a touch panel with a display screen assuming a substantially rectangular shape;
a display control unit that displays specific simple information over part of the display screen along a side of the display screen or in a corner of the display screen; and
a touch position detection unit that detects a touch in a display area where the simple information is provided and then detects that a touch position of the touch has moved inward from an edge of the display screen, wherein:
as the touch position detection unit detects that the touch position has moved, the display control unit displays at the display screen detailed information related to the simple information.

2. A navigation device according to claim 1, wherein:
the display control unit displays the simple information in a display screen in which a roadmap is displayed; and
the touch position detection unit detects that the touch position has moved from the display area for the simple information into the display area for the roadmap.

3. A navigation device according to claim 2, wherein:
as the detailed information is brought up on display, the display control unit displays simple roadmap information related to the roadmap along a side of the display screen or in a corner of the display screen; and
as a touch in a display area for the simple roadmap information is detected and then a the touch position of the touch is detected to have moved from the display area for the simple roadmap information to the display area for the detailed information, the display control unit displays the roadmap and displays the simple information related to the detailed information along a side of the display screen or in a corner of the display screen.

4. A navigation device according to claim 1, further comprising:
an audio function operation unit that executes operation by engaging an audio function, wherein:
the simple information is simple information related to the operation executed by engaging the audio function; and
the detailed information is detailed information related to the operation executed by engaging the audio function.

5. A navigation device according to claim 1, further comprising:
a traffic information reception unit that receives traffic information, wherein:
the simple information is a simplified version of the traffic information; and
the detailed information is a detailed version of the traffic information.

6. A navigation device according to claim 1, wherein:
the display control unit displays a plurality of types of simple information in different display areas.

7. A navigation device according to claim 1, wherein:
the display control unit alters contents of the detailed information in correspondence to the touch position at which the display area for the simple information is touched, as detected by the touch position detection unit.

8. A navigation device according to claim 1, wherein:
the display control unit alters contents of the simple information on display as a touch in the display area for the simple information is detected.

9. A simple/detailed information display method, comprising:
displaying a specific type of simple information at a display monitor equipped with a touch panel disposed at a substantially rectangular display screen, over part of the display screen along a side of the display screen or in a corner of the display screen;
detecting a touch in a display area where the simple information is provided and then detecting that a touch position of the touch has moved inward from an edge of the display screen; and
displaying detailed information related to the simple information over the display screen upon detecting that the touch position has moved.
